(19) United States
(12) Patent Application Publication
(10) Pub. No.: US 2014/0252118 A1
(43) Pub. Date: Sep. 11, 2014

(54) SPRAY COATING APPARATUS

(71) Applicants: Tai-Cheng Tsai, Tainan City (TW); Gwo-Jiun Sheu, Tainan City (TW); Chin-Hua Hung, Tainan City (TW); Po-Jen Su, Tainan City (TW)

(72) Inventors: Tai-Cheng Tsai, Tainan City (TW); Gwo-Jiun Sheu, Tainan City (TW); Chin-Hua Hung, Tainan City (TW); Po-Jen Su, Tainan City (TW)

(73) Assignee: GENESIS PHOTONICS INC., Tainan City (TW)

(21) Appl. No.: 13/904,013

(22) Filed: May 28, 2013

(30) Foreign Application Priority Data
Mar. 5, 2013 (TW) 102107731

(51) Int. Cl. B05B 12/00

(52) U.S. Cl. CPC B05B 12/008
USPC 239/74

(57) ABSTRACT

A spray coating apparatus including a containing tank, a spray nozzle, and a detection unit is provided. The containing tank contains a glue. The spray nozzle is connected to the containing tank to spray and coat the glue on a work piece. The detection unit detects specification data of the glue on the work piece.

### CROSS-REFERENCE TO RELATED APPLICATION

This application claims the priority benefit of Taiwan application serial no. 102107731, filed on Mar. 5, 2013. The entirety of the above-mentioned patent application is hereby incorporated by reference herein and made a part of this specification.

### BACKGROUND

1. Technical Field

The invention relates to a spray coating apparatus. Particularly, the invention relates to a spray coating apparatus of glue.

2. Related Art

Presently, a method for forming a fluorescent glue layer includes dispensing and spray coating. The fluorescent glue layer formed through dispensing may have a problem of uneven distribution of thickness and concentration, which influences color evenness of light emitted from a light-emitting diode (LED). For example, when a blue light emitted from a blue LED chip passes through a thicker part of a yellow fluorescent glue layer, an almost yellow liked light is generated. If the fluorescent glue layer is formed through spray coating, although the drawback of the dispensing method is avoided, since the amount of glue sprayed from a spray nozzle cannot be learned immediately, the sprayed glue amount cannot be immediately adjusted by adjusting a total pressure of a glue tank. Therefore, when the total pressure of the glue tank is decreased as the glue decreases, the amount of the glue sprayed from the spray nozzle is correspondingly decreased, which influences an effect of the spray coating process. Therefore, it is a technique worthy of exploring to effectively improve a spray coating yield.

### SUMMARY

The invention is directed to a spray coating apparatus, which is capable of improving a spray coating yield.

The invention provides a spray coating apparatus including a containing tank, a spray nozzle, and a detection unit. The containing tank contains a glue. The spray nozzle is connected to the containing tank to spray and coat the glue on a work piece. The detection unit detects specification data of the glue on the work piece.

In an embodiment of the invention, the detection unit includes a weight meter.

In an embodiment of the invention, the specification data includes a weight of the glue.

In an embodiment of the invention, the detection unit includes a lightwave generator and a lightwave receiver. The lightwave generator is adapted to emit a lightwave signal to the glue on the work piece to generate the specification data. The lightwave receiver receives the specification data to learn a spray coating amount of the spray nozzle.

In an embodiment of the invention, the glue includes a fluorescent glue, and the specification data includes a refractive index of the glue or a light intensity of the glue.

In an embodiment of the invention, the spray coating apparatus further includes a controller and an adjustor. The controller is connected to the detection unit and receives the specification data to generate adjusting data. The adjustor is connected to the containing tank and the controller, wherein the adjustor receives the adjusting data and adjusts a spray coating amount of the spray nozzle according to the adjusting data.

In an embodiment of the invention, the spray coating apparatus further includes a cleaning unit, and the cleaning unit is disposed at a side of the containing tank and is connected to the adjustor to clean the spray nozzle.

In an embodiment of the invention, the cleaning unit is a gas spray gun or a wipe head.

In an embodiment of the invention, the spray coating apparatus further includes a gas pressure unit, which is connected to the containing tank and the adjustor, wherein the adjustor adjusts a gas pressure of the gas pressure unit according to the adjusting data, so as to adjust the spray coating amount of the spray nozzle.

In an embodiment of the invention, the controller includes a computer.

In an embodiment of the invention, the adjustor includes an actuator.

In an embodiment of the invention, the spray coating apparatus further includes a firing pin, a control valve and a pipe, wherein the firing pin is connected to the adjustor, the containing tank is connected to the spray nozzle through the pipe and the control valve, and the control valve is connected to the spray nozzle and the firing pin.

According to the above descriptions, since the spray coating apparatus of the invention has the detection unit, the specification data of the glue on the work piece can be immediately detected, and the user can learn a spray coating situation of the spray nozzle according to the specification data. In this way, the problem of inconsistency of the spray coating amount can be avoided to improve the spray coating yield.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a spray coating apparatus according to an embodiment of the invention.

FIG. 2 is a schematic diagram of a spray coating apparatus according to another embodiment of the invention.

FIG. 3 is a schematic diagram of a spray coating apparatus according to still another embodiment of the invention.

FIG. 4 is a schematic diagram of a spray coating apparatus according to yet another embodiment of the invention.

FIG. 5 is a schematic diagram of a spray coating apparatus according to yet another embodiment of the invention.

### DETAILED DESCRIPTION OF DISCLOSED EMBODIMENTS

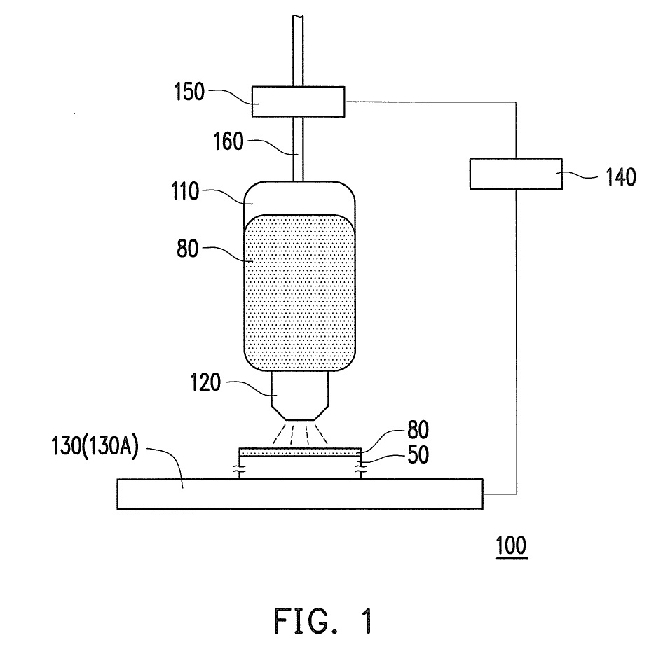

FIG. 1 is a schematic diagram of a spray coating apparatus according to an embodiment of the invention. Referring to FIG. 1, the spray coating apparatus 100 of the present embodiment includes a containing tank 110, a spray nozzle 120, and a detection unit 130. The containing tank 110 contains a glue 80. The spray nozzle 120 is connected to the containing tank 110 to spray and coat the glue 80 on a work piece 50.

In the present embodiment, the detection unit 130 detects specification data of the glue 80 on the work piece 50, and a user can immediately monitor a spray coating situation of the glue 80 according to the specification data, so as to avoid a problem of inconsistency of a spray coating amount, and improve a spray coating yield of the spray coating apparatus 100. Here, the detection unit 130 is, for example, a weight meter 130A, and the specification data includes a weight of the glue 80 on the work piece 50. In other words, in the present embodiment, the weight meter 130A is used to detect the weight of the glue 80 on the work piece 50, so as to get a spray coating amount of the spray nozzle 120.

In detail, in the present embodiment, the spray coating apparatus 100 further includes a controller 140 and an adjustor 150. The controller 140 is connected to the detection unit 130 and receives the specification data to generate adjusting data. The adjustor 150 is connected to the containing tank 110 and the controller 140, wherein the adjustor 150 receives the adjusting data and adjusts the spray coating amount of the spray nozzle 120 according to the adjusting data. In the present embodiment, after the weight meter 130A detects the weight (the specification data) of the glue 80 on the work piece 50, the controller 140, for example, a computer receives the specification data and calculates a thickness of the glue 80 on the work piece 50 according to the specification data, so as to deduce the spray coating amount of the spray nozzle 120, and generates the adjusting data according to the spray coating amount. Then, the adjustor 150, for example, an actuator receives the adjusting data and adjusts the spray coating amount of the spray nozzle 120. Moreover, in the present embodiment, the spray coating apparatus 100 may further include a gas pressure unit 160, for example, a gas pressure pipe. The gas pressure unit 160 is connected to the containing tank 110 and the adjustor 150, wherein the adjustor 150 adjusts a gas pressure of the gas pressure unit 160 according to the adjusting data, so as to adjust the spray coating amount of the spray nozzle 120.

For example, when the thickness of the glue 80 on the work piece 50 is too thick, the weight measured by the weight meter is heavier, and it is deduced that the spray coating amount of the spray nozzle 120 is too larger. Now, the adjustor 150 turns down the gas pressure of the gas pressure unit 160 according to the received adjusting data to decrease the spray coating amount of the spray nozzle 120. Conversely, when the thickness of the glue 80 on the work piece 50 is too thin, the weight measured by the weight meter is lighter, and it is deduced that the spray coating amount of the spray nozzle 120 is too small. Now, the adjustor 150 turns up the gas pressure of the gas pressure unit 160 according to the received adjusting data to increase the spray coating amount of the spray nozzle 120. In this way, besides that the spray coating apparatus 100 can immediately learn the spray coating amount of the spray nozzle 120 according to the specification data, the spray coating apparatus 100 can also immediately adjust the spray coating amount of the spray nozzle 120 through the controller 140 and the adjustor 150, so as to stabilize the thickness of the sprayed and coated glue 80, and accordingly improve the whole spray coating yield of the spray coating apparatus 100.

It should be noticed that reference numbers of the components and a part of contents of the aforementioned embodiment are also used in the following embodiment, wherein the same reference numbers denote the same or like components, and descriptions of the same technical contents are omitted. The aforementioned embodiment can be referred for descriptions of the omitted parts, so that detailed descriptions thereof are not repeated in the following embodiment.

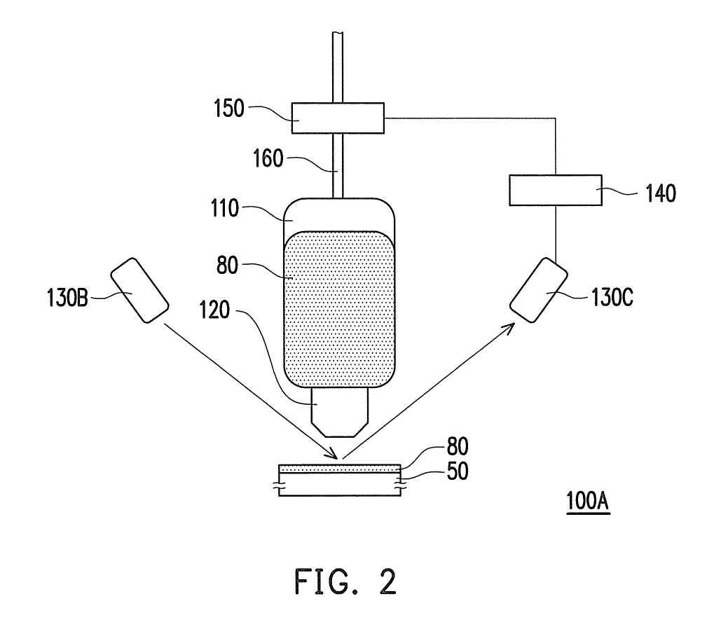

FIG. 2 is a schematic diagram of a spray coating apparatus according to another embodiment of the invention. Referring to FIG. 2, the spray coating apparatus 100A of the present embodiment is similar to the spray coating apparatus 100 of FIG. 1, and a difference there between is that the detection unit of the present embodiment is composed of a lightwave generator 130B and a lightwave receiver 130C. In detail, the lightwave generator 130B is adapted to emit a lightwave signal to the glue 80 on the work piece 50 to generate the specification data. The lightwave receiver 130C receives the specification data to learn the spray coating amount of the spray nozzle 120. In the present embodiment, the glue 80 includes a fluorescent glue, and the specification data includes a refractive index of the glue 80 or a light intensity of the glue 80. According to the refractive index or the light intensity (the specification data) of the glue 80 on the work piece 50, the lightwave receiver 130C can receive thickness data of the glue 80 on the work piece 50 to deduce the spray coating amount of the spray nozzle 120, and in collaboration with the controller 140 and the adjustor 150, the spray coating apparatus 100A can immediately adjust the spray coating amount of the spray nozzle 120 to stabilize the thickness of the sprayed and coated glue 80, so as to improve the whole spray coating yield of the spray coating apparatus 100A.

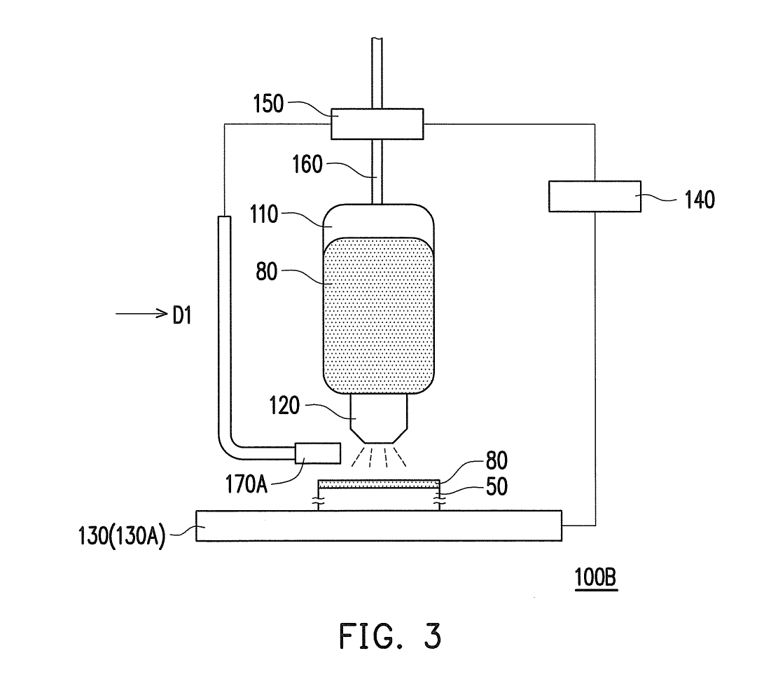

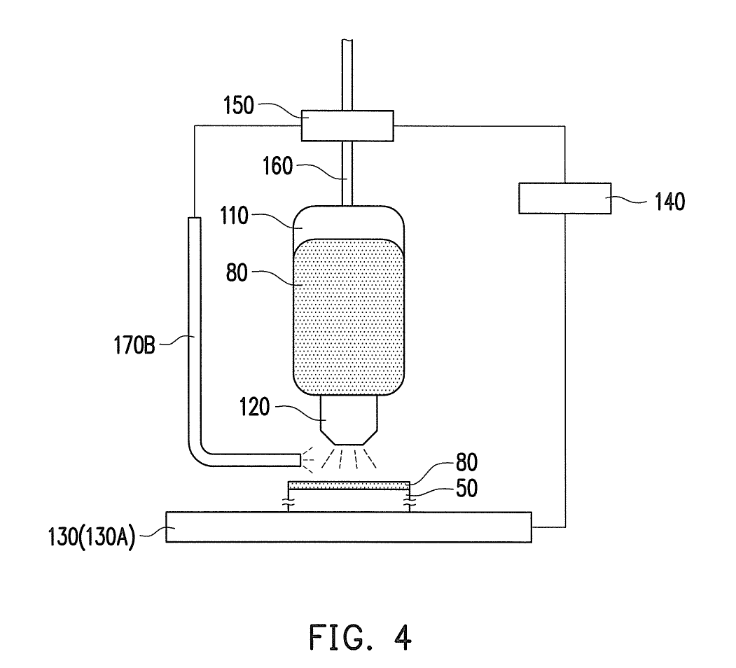

FIG. 3 is a schematic diagram of a spray coating apparatus according to still another embodiment of the invention. Referring to FIG. 3, the spray coating apparatus 100B of the present embodiment is similar to the spray coating apparatus 100 of FIG. 1, and a difference there between is that the spray coating apparatus 100B further includes a cleaning unit 170A. The cleaning unit 170A is disposed at a side of the containing tank 110 and is connected to the adjustor 150. When the controller 140 receives the specification data and deduces that the spray coating amount is too small, the controller 140 generates adjusting data according to the spray coating amount. Then, the adjustor 150, for example, an actuator receives the adjusting data and adjusts the spray coating amount of the spray nozzle 120, and the spray nozzle 120 sprays and coats the glue 80 on the work piece 50 according to the adjusted spray coating amount. When the detection unit 130 receives the specification data and gets that the spray coating amount is too small, the controller 140 may determine that the spray nozzle 120 of the spray coating apparatus 100B is jammed, and generate spray nozzle cleaning data. The adjustor 150 can receive the spray nozzle cleaning data and drive the cleaning unit 170A to clean the spray nozzle 120. Alternatively, the controller 140 can generate the spray nozzle cleaning data in an idle phase of device operation, and the adjustor 150 receives the spray nozzle cleaning data and drives the cleaning unit 170A to clean the spray nozzle 120. In this way, a phenomenon of uneven spraying and coating due to jam of the spray nozzle 120 can be avoided. In the present embodiment, the cleaning unit 170A is a wipe head, which conducts a reciprocating motion along a wiping direction D1 to achieve a wiping effect. Certainly, the operation manner of the cleaning unit 170A is not limited to the contact type operation manner of FIG. 3. In other embodiments, referring to FIG. 4, a cleaning unit 170B can also be gas spray gun, which is still a technical solution that can be adopted by the invention without departing from a protection range of the invention.

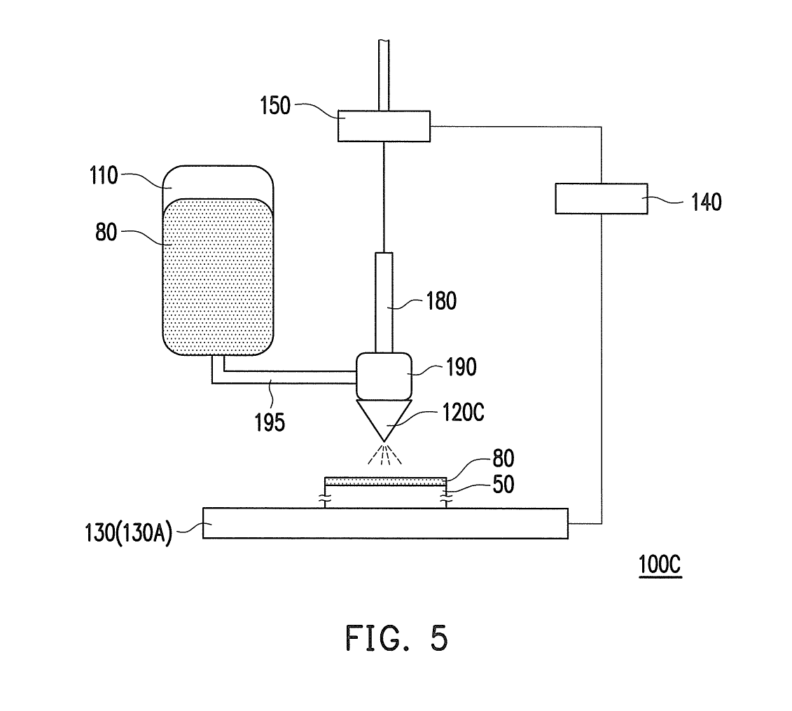

FIG. 5 is a schematic diagram of a spray coating apparatus according to yet another embodiment of the invention. Referring to FIG. 5, the spray coating apparatus 100C of the present embodiment is similar to the spray coating apparatus 100 of FIG. 1, and a difference there between is that the spray coating apparatus 100C does not use the gas pressure unit 160 of FIG. 1 to adjust the spray coating amount of the spray nozzle 120, but executes the same through a firing pin. In detail, the spray coating apparatus 100C further includes a firing pin 180, a control valve 190 and a pipe 195, wherein the firing pin 180 is connected to the adjustor 150, the control valve 190 is connected to the firing pin 180 and the spray nozzle 120C, and the containing tank 110 is connected to the spray nozzle 120C through the pipe 195 and the control valve 190.

In the present embodiment, the adjustor 150 can adjust an impact frequency of the firing pin 180 to increase or decrease the spray coating amount of the spray nozzle 120C. In this way, the spray coating apparatus 100C of the present embodiment can immediately learn the spray coating amount of the spray nozzle 120 according to the specification data, the spray coating apparatus 100C can also immediately adjust the impact frequency of the firing pin 180 to adjust the spray coating amount of the spray nozzle 120C through the controller 140 and the adjustor 150, so as to stabilize the thickness of the sprayed and coated glue 80, and accordingly improve the whole spray coating yield of the spray coating apparatus 100C.

In summary, since the spray coating apparatus of the invention has the detection unit, the specification data of the glue on the work piece can be immediately detected, and the user can learn a spray coating situation of the spray nozzle according to the specification data. In this way, the problem of inconsistency of the spray coating amount can be avoided to improve the whole spray coating yield of the spray coating apparatus. Moreover, the detection unit can be the weight meter or a combination of the lightwave generator and the lightwave receiver, so that the spray coating apparatus has good design flexibility. In addition, the spray coating apparatus can adjust the spray coating amount of the spray nozzle through the controller and the adjustor according to the received specification data, so as to stabilize the thickness of the sprayed and coated glue. In this way, the spray coating apparatus of the invention provides a stable spray coating amount, and has a good spray coating yield.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A spray coating apparatus, comprising:
a containing tank, containing a glue;
a spray nozzle, connected to the containing tank to spray and coat the glue on a work piece; and
a detection unit, detecting specification data of the glue on the work piece.

2. The spray coating apparatus as claimed in claim 1, wherein the detection unit comprises a weight meter.

3. The spray coating apparatus as claimed in claim 2, wherein the specification data comprises a weight of the glue.

4. The spray coating apparatus as claimed in claim 1, wherein the detection unit comprises:
a lightwave generator, adapted to emit a lightwave signal to the glue on the work piece to generate the specification data; and
a lightwave receiver, receiving the specification data to learn a spray coating amount of the spray nozzle.

5. The spray coating apparatus as claimed in claim 4, wherein the glue comprises a fluorescent glue, and the specification data comprises a refractive index of the glue or a light intensity of the glue.

6. The spray coating apparatus as claimed in claim 1, further comprising:
a controller, connected to the detection unit, and receiving the specification data to generate adjusting data; and
an adjustor, connected to the containing tank and the controller, wherein the adjustor receives the adjusting data and adjusts a spray coating amount of the spray nozzle according to the adjusting data.

7. The spray coating apparatus as claimed in claim 6, further comprising:
a cleaning unit, disposed at a side of the containing tank and connected to the adjustor to clean the spray nozzle.

8. The spray coating apparatus as claimed in claim 7, wherein the cleaning unit is a gas spray gun or a wipe head.

9. The spray coating apparatus as claimed in claim 6, further comprising a gas pressure unit connected to the containing tank and the adjustor, wherein the adjustor adjusts a gas pressure of the gas pressure unit according to the adjusting data, so as to adjust the spray coating amount of the spray nozzle.

10. The spray coating apparatus as claimed in claim 6, wherein the controller comprises a computer.

11. The spray coating apparatus as claimed in claim 6, wherein the adjustor comprises an actuator.

12. The spray coating apparatus as claimed in claim 6, further comprising a firing pin, a control valve and a pipe, wherein the firing pin is connected to the adjustor, the containing tank is connected to the spray nozzle through the pipe and the control valve, and the control valve is connected to the spray nozzle and the firing pin.
